(19) United States
(12) Patent Application Publication
(10) Pub. No.: US 2025/0145539 A1
(43) Pub. Date: May 8, 2025

(54) METHOD FOR IMPROVING THE STRENGTH OF CONCRETE MATERIAL

(71) Applicant: CONCRETE4CHANGE LTD, Gloucestershire (GB)

(72) Inventors: Michael WISE, Nottinghamshire (GB); Sid POURFALAH, Nottinghamshire (GB)

(73) Assignee: CONCRETE4CHANGE LTD, Gloucestershire (GB)

(21) Appl. No.: 18/837,004

(22) PCT Filed: Apr. 6, 2023
(86) PCT No.: PCT/GB2023/050938

§ 371 Date: Aug. 8, 2024

(30) Foreign Application Priority Data
Feb. 10, 2022 (GB) 2201756.0

(51) Int. Cl. C04B 40/02; C04B 22/02; C04B 40/00

(52) U.S. Cl. CPC C04B 40/0231; C04B 22/02; C04B 40/0082; C04B 40/0089; C04B 40/024

(57) ABSTRACT

Aspects and embodiments of the present invention relate to method for the preparation of a concrete material or cementitious material, comprising the steps of: providing a carrier comprising adsorbed carbon dioxide; mixing the carrier comprising adsorbed carbon dioxide into a concrete mix or cementitious material to form a concrete-carrier mix; and wherein, during the curing process to form the concrete material, the carbon dioxide is released from the carrier in the concrete-carrier mix and becomes sequestered within the concrete material.

This invention relates to methods for the preparation of a cementitious material in which carbon dioxide (CO₂) becomes sequestered therein. The invention relates also to the cementitious material itself and structures comprising the cementitious material, uses of the cementitious material and an apparatus for preparing the cementitious material.

Cementitious composites, such as concrete mixes, are used in a multitude of compositions and procedures throughout the world. Concrete is the second most consumed material in the world (second only to water) and accounts for 8% of the global CO₂ emissions. Mitigation of greenhouse gases such as carbon dioxide are essential to limit global heating.

The permanent mineralisation of CO₂ as calcium carbonate in concrete (sequestration) is used as a carbon capture utilisation and storage (CCUS) method. In this case, calcium hydroxide in the concrete mix reacts with the CO₂ to form calcium carbonate. The composition of cement mixes can provide a permanent store for carbon dioxide emissions. References to a concrete material herein shall be considered equally applicable to other cementitious materials. For example, it is known that liquefied carbon dioxide may be injected into a concrete mix during mixing of the batched concrete ingredients in a ready-mixed truck, or freshly mixed concrete may be exposed to a stream of gaseous CO₂.

However, these methods are problematic as it can be difficult to determine how much carbon dioxide is retained in the concrete mix and so how much carbon dioxide is sequestered in the resulting concrete material. This method is highly inefficient due to losses in CO2 to the atmosphere during the mixing process. It is also extremely difficult to control the rate of the reaction which may have negative effects on the strength of concrete. Further, the direct mixing of liquid or gaseous carbon dioxide into a concrete mix can result in the accumulation and uneven distribution of calcium carbonate in the concrete microstructure.

There is a need for improvements in methods for delivering carbon dioxide into a concrete mix in order to sequester carbon dioxide and further achieving desirable properties of the resulting concrete.

The present invention addresses one or more of the above described problems.

According to a first aspect of the invention, there is provided a method for the improving a strength, durability, and/or early stage performance of a concrete material, the method comprising the steps of: providing a carrier suitable for carbon dioxide adsorption; modifying the carrier to alter a carbon dioxide desorption rate thereof, forming a modified carrier; passing carbon dioxide from a carbon dioxide source over the modified carrier to form a carrier comprising adsorbed carbon dioxide; mixing the carrier comprising adsorbed carbon dioxide into a wet, semi-dry or dry concrete mix to form a concrete carrier mix; and wherein, during the curing process to form the concrete material, the carbon dioxide is released from the carrier in the concrete-carrier mix and becomes sequestered within the concrete material.

In the present invention, a carrier is provided, and which is then modified so as to alter the desorption characteristics thereof. Desirable desorption characteristics are slow-release once the modified carrier is added to a concrete mix, either in the wet or dry form. The present invention achieves slow-release of carbon dioxide into the concrete as it cures. This slow release allows for an optimum amount of carbon dioxide to be sequestered therein for improving the strength of the concrete. The carrier selected within the present invention is chosen so that it can be added to standard concrete mixtures, without the need for, for example, pH modification of the concrete mixture to achieve desirable carbon dioxide release characteristics. Indeed, the carrier has the advantage of acting as a buffer itself to prevent too great of a pH drop during the curing process.

Preferably, the carbon dioxide desorption rate of the modified carrier may be in the range of 0.0001 to 0.37 mmol/g/h.

Preferably, the carbon dioxide desorption rate of the modified carrier may be in the range of 0.0001 to 0.18 mmol/g/h.

Preferably, a rate of carbon dioxide uptake in the concrete material may be less than 0.4 mmol/g/h, where the weight is the weight of reactive agent from the binder of the concrete mix.

Preferably, the carrier may comprise adsorbed carbon dioxide is selected so as to release a predetermined amount of carbon dioxide during the curing process over a predetermined time period, to thereby achieve a desired increase in compressive strength of the concrete material.

Preferably, the predetermined amount of carbon dioxide may be a percentage by weight of carbon dioxide relative to a weight of cement in the concrete-carrier mix.

Preferably, the predetermined amount of carbon dioxide may be 1.5% carbon dioxide relative to a weight of binder in the concrete-carrier mix within 24 to 1344 hours.

Optionally, the compressive strength of the concrete material is increased by between 5 and 25%.

Alternatively, a weight of binder in the concrete-carrier mix may be reduced by between 5 and 20% relative to a standard concrete mix. A standard concrete mix would usually include binder, such as cement, in a weight of 10 to 20% of the weight of the concrete mix, though sometimes in a percentage up to 30%.

Preferably, the predetermined amount of carbon dioxide may be 5% carbon dioxide relative to a weight of binder in the concrete-carrier mix within 24 to 1344 hours.

Optionally, the compressive strength of the concrete material is increased by between 10 and 40%.

Alternatively, a weight of binder in the concrete-carrier mix may be reduced by between 5 and 35% relative to a standard concrete mix.

Preferably, the predetermined amount of carbon dioxide may be 20% carbon dioxide relative to a weight of binder in the concrete-carrier mix within 24 to 1344.

Optionally, the compressive strength of the concrete material is increased by between 20 and 100%.

Alternatively, a weight of binder in the concrete-carrier mix may be reduced by between 20 and 50% relative to a standard concrete mix.

It is desirable to specifically modify the carrier being used, within the present invention, to achieve specific advantageous properties of the concrete that is subsequently formed.

Preferably, the curing process may occur over 2 to 12 days, and wherein at least 50% of the adsorbed carbon dioxide of the modified carrier is released during the curing process.

Preferably, heat, reduced pressure and/or steam may be applied to the concrete-carrier mix.

Preferably, the carbon dioxide may be passed over the carrier under pressure to form the carrier comprising adsorbed carbon dioxide.

Preferably, the carbon dioxide may be passed over the carrier at a pressure of above 2 bara, optionally between 2 and 3.5 bara, optionally at above 1 bara, optionally up to 100 bara.

Preferably, the adsorption of carbon dioxide to form the carrier comprising adsorbed carbon dioxide may take place in a fluidised bed reactor, fixed bed reactor or in a stirred tank reactor in order to adsorb CO₂ and transfer it to cementitious material.

Preferably, the source of carbon dioxide may be flue gases, wherein the purity of carbon dioxide is preferably at least 20% in the flue gas, atmospheric air, or a gas canister.

Preferably, the carrier may be activated carbon; silica support; zeolites; porous aluminosilicate polymorphs; porous carbons; porous polymer networks; porous inorganic oxides; metal-organic-frameworks, zeolitic imidazolate frameworks; diethanolamine (DEA) upon an acrylic ester polymer resin; tetraethylenepentaamineacrylonitrile (TEPAN) upon non-ionic; polymeric polmethylmethacrylate (PMMA) beads; aminopropyltriethoxysilane bonded to silica gel; polyethylenimine (PEI) and polyethylene glycol (PEG) impregnated onto the surface of fly ash derived carbons; PEI immobilized on a mesoporous silica support; and polyoligosiloxysilicones. More preferably, the activated carbon may be derived from waste lignocellulosic and plastic materials.

Preferably, the modified carrier may be formed by treating the carrier with an activating agent or surface modifying agent. Preferably, the activating agent increases the capacity of the carrier for carbon dioxide adsorption up to around 25 wt %.

Preferably, the activating agent or surface modifying agent may be any one of: potassium hydroxide;

sodium hydroxide; magnesium hydroxide; magnesium chloride; ammonium chloride; zinc chloride; potassium carbonate; sodium carbonate; potassium tetraborate; potassium oxalate; potassium phosphate; ammonia; nitric acid; hydrochloric acid; phosphoric acid; ammonia; nitric acid; hydrogen cyanide; urea; sodium amide; pyridine; melamine; polyaniline; aminoalkyltrialkoxysilane; cyclic acid anhydride; branched polyethylene amine; chemical oxidants; carbodiimide activating agents; or polymeric surface functionalization compound.

Preferably, the concrete mix may comprise one or more of ground granulated blast furnace slag and/or fly ash, Cement type 1, 2, 3, 4, 5 or 6 and/or any other cementitious material, most preferably, cement type 1.

Optionally, an amount of cement or other binder in the concrete mix may be reduced based on a selected amount of modified carrier added.

According to a second aspect of the invention, there is provided a concrete material prepared by the method according to the first aspect of the invention.

According to a third aspect of the invention there is provided a structure comprising a concrete material according to the second aspect of the invention.

Further according to the invention, there is provided a method for the preparation of a concrete material, comprising the steps of:
providing a carrier comprising adsorbed carbon dioxide;
mixing the carrier comprising adsorbed carbon dioxide into a concrete mix to form a concrete-carrier mix; and

wherein, during the process to form the concrete, the carbon dioxide is released from the carrier in the concrete-carrier mix and becomes sequestered within the concrete material.

The method of the invention may comprise the further step of allowing the concrete-carrier mix to react to give the concrete extra strength. Heat, reduced pressure, water and/or steam may be applied to the concrete-carrier mix in order to aid or speed up the curing process.

The method of the invention may comprise the step of passing carbon dioxide from a carbon dioxide source over the carrier to form the carrier comprising adsorbed carbon dioxide. The carbon dioxide may be passed over the carrier under pressure to form the carrier comprising adsorbed carbon dioxide. For example, the carbon dioxide may be passed over the carrier at a pressure of above 2 bara, or optionally between 2 and 3.5 bara or optionally in excess of 3.5 bara. The carbon dioxide may also be passed at ambient atmospheric conditions.

The carrier may be weighed before and after adsorption of carbon dioxide in order to easily determine how much carbon dioxide has been adsorbed onto the carrier. In this way, the carrier comprising the adsorbed carbon dioxide can be used to deliver a known and predetermined quantity of carbon dioxide into the concrete mix. The quantity of the adsorbed carbon dioxide may also be determined from the gas flowrate and pressure drop in the reactor.

The use of a carrier to deliver the carbon dioxide into the concrete mix also provides some bulk to enable effective and thorough mixing of the carbon dioxide into the concrete mix, as compared with gaseous carbon dioxide alone, for example. In this way, the carbon dioxide can be evenly distributed into the concrete mix, which in turn results in an even distribution of calcium carbonate in the concrete microstructure. The uniform distribution of the carbon dioxide may be monitored using the concrete pH.

The sequestration of carbon dioxide, a greenhouse gas, in concrete advantageously enhances the mechanical properties of concrete, including the enhancement of compressive strength, durability and reduction of porosity. The use of a carrier to deliver a known quantity of carbon dioxide and to evenly distribute the carbon dioxide enables the mechanical properties of concrete to be carefully selected and tailored to a particular need. Herein disclosed is a method for delivering carbon dioxide to the concrete or cementitious material through solid, liquid and/or polymeric carriers via sorption. A specific methodology for the delivery and release of CO₂ into concrete implemented to maximise the reaction of CO₂ with concrete, allowing the optimum reaction of calcium hydroxide with the CO₂ to form calcium carbonate. This reaction enhances the mechanical properties of concrete, including the enhancement of compressive strength, durability and reduction of porosity. As a result of the enhanced mechanical properties, the cementitious content of concrete (i.e. cement) can be reduced significantly. This allows the reduction of the overall carbon footprint of concrete through direct sequestration and/or material reduction.

The said method comprising an extraction cycle, wherein said extraction cycle comprises (i) a sorption step wherein carbon dioxide in gases is adsorbed to a porous material, wherein said porous material contacts said gas stream; and (ii) a transfer step wherein said carrier loaded with carbon dioxide is transferred to the cementitious mix; (iii) the desorption step wherein said adsorbed carbon dioxide obtained at the end of said sorption step is released from said porous material as gaseous carbon dioxide. The condition in the mix is designed to optimise the chemical, mechanical properties and the durability of the produced concrete. (iv) a pressure sensor proximal to the outlet and configured to detect a first Pressure, P, of carbon dioxide in the delivery line and to transmit the detected first pressure to a load calculation. (v) In certain situations, carbon dioxide is delivered using a secondary solid, liquid and/or polymeric carrier into the cementitious mixture. Carbon dioxide is loaded onto the carrier material and transferred to the cementitious mixture. It is desirable to determine the flow rate of the carrier and/or total amount of carrier delivered. It is also desirable to determine the rate of carbon dioxide release, reaction and mineralization at the mixing and setting conditions. In addition, it is often desirable to deliver such a carrier to a mix, such as a cement mix, using apparatus and methods to optimize the uptake of the carbon dioxide into the mix.

In an embodiment, during a sorption step, carbon dioxide in the gas is adsorbed with a high selectivity to a porous material, wherein said porous material contacts said gas stream.

In an embodiment, in the sorption step, a porous material contacts a gas stream, meaning that a significant part of the outer surface of said porous material is in contact with said gas. Optionally, said significant part of the outer surface is at least 50%, or at least 55%, or at least 60%, or at least 65%, or at least 70%, or at least 75%, or at least 80%, or at least 85%, or at least 90%, or at least 95%, or 100% of said outer surface. In a preferred method according to the invention said porous material at least 50%, or at least 55%, or at least 60%, or at least 65%, or at least 70%, or at least 75%, or at least 80%, or at least 85%, or at least 90%, or at least 95%, or 100% of the outer surface is submerged in said gas stream.

In an embodiment, during a desorption step, adsorbed carbon dioxide obtained at the end of a sorption step is released from the porous material used in said sorption step as gaseous carbon dioxide carbonating the concrete.

The release of adsorbed carbon dioxide as gaseous carbon dioxide means that a carbon dioxide, adsorbed to a porous material via chemisorption and/or physisorption, is desorbed from said porous material and is transferred to a gas phase, free to carbonate the concrete.

In an embodiment, gaseous carbon dioxide released in said desorption step is present in a gas phase with a concentration of at least 60 mol %, or at least 61 mol %, or at least 62 mol %, or at least 63 mol %, or at least 64 mol %, or at least 65 mol %, or at least 66 mol %, or at least 67 mol %, or at least 68 mol %, or at least 69 mol %, or at least 70 mol %, or at least 71 mol %, or at least 72 mol %, or at least 73 mol %, or at least 74 mol %, or at least 75 mol %, or at least 76 mol %, or at least 77 mol %, or at least 78 mol %, or at least 79 mol %, or at least 80 mol %, or at least 81 mol %, or at least 82 mol %, or at least 83 mol %, or at least 84 mol %, or at least 85 mol %, or at least 86 mol %, or at least 87 mol %, or at least 88 mol %, or at least 89 mol %, or at least 90 mol %, or at least 91 mol %, or at least 92 mol %, or at least 93 mol %, or at least 94 mol %, or at least 95 mol %, or at least 96 mol %, or at least 97 mol %, or at least 98 mol %, or at least 99 mol %.

In an embodiment, gaseous carbon dioxide released in said desorption step is present in a gas phase with a concentration lower than 99 mol %, or lower than 98 mol %, or lower than 97 mol %, or lower than 96 mol %, or lower than 95 mol %, or lower than 94 mol %, or lower than 93 mol %, or lower than 92 mol %, or lower than 91 mol %, or lower than 90 mol %, or lower than 90 mol %, or lower than 89 mol %, or lower than 88 mol %, or lower than 87 mol %, or lower than 86 mol %, or lower than 85 mol %, or lower than 84 mol %, or lower than 83 mol %, or lower than 82 mol %, or lower than 81 mol %, or lower than 80 mol %, or lower than 79 mol %, or lower than 78 mol %, or lower than 77 mol %, or lower than 76 mol %, or lower than 75 mol %, or lower than 74 mol %, or lower than 73 mol %, or lower than 72 mol %, or lower than 71 mol %, or lower than 70 mol %, or lower than 69 mol %, or lower than 68 mol %, or lower than 67 mol %, or lower than 66 mol %, or lower than 65 mol %, or lower than 64 mol %, or lower than 63 mol %, or lower than 62 mol %, or lower than 61 mol %, or lower than 60 mol %, or lower than 59 mol %, or lower than 58 mol %, or lower than 57 mol %, or lower than 56 mol %, or lower than 55 mol %, or lower than 54 mol %, or lower than 53 mol %, or lower than 52 mol %, or lower than 51 mol %, or lower than 50 mol %, or lower than 49 mol %, or lower than 48 mol %, or lower than 47 mol %, or lower than 46 mol %, or lower than 45 mol %, or lower than 44 mol %, or lower than 43 mol %, or lower than 42 mol %, or lower than 41 mol %, or lower than 40 mol %, or lower than 39 mol %, or lower than 38 mol %, or lower than 37 mol %, or lower than 36 mol %, or lower than 35 mol %, or lower than 34 mol %, or lower than 33 mol %, or lower than 32 mol %, or lower than 31 mol %, or lower than 30 mol %, or lower than 29 mol %, or lower than 28 mol %, or lower than 27 mol %, or lower than 26 mol %, or lower than 25 mol %, or lower than 24 mol %, or lower than 23 mol %, or lower than 22 mol %, or lower than 21 mol %, or lower than 20 mol %, or lower than 19 mol %, or lower than 18 mol %, or lower than 17 mol %, or lower than 16 mol %, or lower than 15 mol %, or lower than 14 mol %, or lower than 13 mol %, or lower than 12 mol %, or lower than 11 mol %, or lower than 10 mol %, or lower than 9 mol %, or lower than 8 mol %, or lower than 7 mol %, or lower than 6 mol %, or lower than 5 mol %, or lower than 4 mol %, or lower than 3 mol %, or lower than 2 mol %, or lower than 1 mol %, or lower than 0.1 mol %. Optionally, said gaseous carbon dioxide released in said desorption step has at least a given concentration as described herein.

In an embodiment, said gaseous carbon dioxide released in said desorption step is present in a gas phase with a concentration from 1 mol % up to 99 mol %, optionally from 75 mol % up to 95 mol %.

The adsorption of carbon dioxide to form the carrier comprising adsorbed carbon dioxide may take place in an adsorption apparatus such as fluidised bed reactor or fixed bed reactor or in a stirred tank reactor, and the source of carbon dioxide may be flue gases, atmospheric air, gas canisters, tanks and/or pipes. A purification adsorption apparatus may be required for the removal of CO2 from CO2 source stream.

The carrier may comprise a porous material. In particular, the carrier may comprise one or more of zeolites, porous aluminosilicate polymorphs, porous carbons, porous polymer networks, porous inorganic oxides, metal-organic-frameworks, zeolitic imidazolate frameworks, diethanolamine (DEA) upon an acrylic ester polymer resin, tetraethylenepentaamineacrylonitrile (TEPAN) upon non-ionic, polymeric polmethylmethacrylate (PMMA) beads, aminopropyltriethoxysilane bonded to silica gel, polyethylenimine (PEI) and polyethylene glycol (PEG) impregnated onto the surface of low cost fly ash derived carbons, PEI immobilised on a mesoporous silica support and polyoligosiloxysilicones.

Optionally, the carrier may comprise one or more of porous carbons and zeolites, and the porous carbons may comprise one or more of carbon black and activated carbon. The carrier may comprise activated carbon. The zeolites may comprise one or more of silicalite-1, H-ZSM-5, faujasite, mordenite and zeolite beta.

In an embodiment, said porous material may comprise one or more of zeolites, porous aluminosilicate polymorphs, porous carbons, porous polymer networks, porous inorganic oxides, metal-organic-frameworks, zeolitic imidazolate frameworks, diethanolamine (DEA) upon an acrylic ester polymer resin, tetraethylenepentaamineacrylonitrile (TEPAN) upon non-ionic, polymeric polmethylmethacrylate (PMMA) beads, aminopropyltriethoxysilane bonded to silica gel, polyethylenimine (PEI) and polyethylene glycol (PEG) impregnated onto the surface of low cost fly ash derived carbons, PEI immobilised on a mesoporous silica support and polyoligosiloxysilicones, optionally wherein said porous material has a specific surface area of at least 100 m²/g, optionally at least 1000 m²/g; and/or, optionally wherein said porous material has a carbon dioxide adsorption capacity of at least 0.8 millimol per gram at 298 Kelvin; and/or, optionally wherein said porous material has a carbon dioxide affinity of at least 1 min⁻¹, optionally 5 min⁻¹ at 298 Kelvin; and/or, optionally wherein said porous material is a selective carbon dioxide adsorber in said liquid; and/or, wherein, said gas is high concentration carbon dioxide stream with impurities. Optionally, said gas is low carbon dioxide from air through Direct Air Capture. Optionally, said gas stream is flue gases.

Optionally, a zeolite may comprise one or more of silicalite-1, H-ZSM-5, faujasite, mordenite and zeolite beta. Optionally, a porous inorganic oxide may comprise one or more of alumina, silica, and titania.

Optionally, a porous carbon may comprise one or more of carbon black, biochar and/or activated carbons.

A material may be a pure material or a composite material. A composite material is a material comprising at least two pure materials, wherein said pure materials are bound together. Said pure materials comprised in a composite material are called the components of said composite material.

Optionally, a composite material is not homogeneous with respect to its components on the centimeter scale. In other words, a composite material according to this preferred definition does not comprise a sphere of at least 1 centimeter wherein said sphere comprises only a single component comprised in said composite material.

Optionally, a composite material is not homogeneous with respect to its components on the millimeter scale. In other words, a composite material according to this preferred definition does not comprise a sphere of at least 1 millimeter wherein said sphere comprises only a single component comprised in said composite material.

Optionally, a composite structure is homogeneous with respect to its components on the millimeter scale. In other words, a composite structure according to this preferred definition comprises a sphere of at least 0.001 millimeter wherein said sphere comprises a single component comprised in said composite structure.

From the above, it is clear that a composite structure is different from a composite material. Whereas a composite structure comprises components that are not bound strongly together and can easily be separated, a composite material comprises components that are bound strongly together and cannot easily be separated.

A porous material is a material comprising pores. The relative volume of pores in a material is called the porosity of said material. Porosity is defined as the fraction of the volume of voids (or empty spaces) comprised in a material over the total volume of said material. Several methods such as nitrogen adsorption and mercury intrusion porosimetry may be used to determine the porosity of a composite material used in a method according to the invention. Scanning Electron Microscope (SEM) may also be used to determine the porosity and pore characteristics of the composite materials in this invention.

In an embodiment, a porous material may be a material having a porosity of at least 20%, or at least 25%, or at least 30%, or at least 35%, or at least 40%, or at least 45%, or at least 50%, or at least 55%, or at least 60%, or at least 65%, or at least 66%, or at least 67%, or at least 68%, or at least 69%, or at least 70%, or at least 71%, or at least 72%, or at least 73%, or at least 74%, or at least 75%, or at least 76%, or at least 77%, or at least 78%, or at least 79%, or at least 80%, or at least 81%, or at least 82%, or at least 83%, or at least 84%, or at least 85%, or at least 86%, or at least 87%, or at least 88%, or at least 89%, or at least 90%, or at least 91%, or at least 92%, or at least 93%, or at least 94%, or at least 95%, or at least 96%, or at least 97%, or at least 98%, or at least 99%.

A parameter related to the porosity is the specific surface area. The specific surface area of a material is defined as the total surface area of said material per unit of mass, wherein said surface may be an internal or an external surface. An internal surface is the surface surrounding a pore. The specific surface area may be measured by applying the Brunauer-Emmett-Teller (BET) theory to nitrogen adsorption.

In an embodiment, said porous material may be a material having a specific surface area of at least 1 m²/g, or at least 2 m²/g, or at least 3 m²/g, or at least 4 m²/g, or at least 5 m²/g, or at least 6 m²/g, or at least 7 m²/g, or at least 8 m²/g, or at least 9 m²/g, or at least 10 m²/g, or at least 15 m²/g, or at least 20 m²/g, or at least 25 m²/g, or at least 30 m²/g, or at least 35 m²/g, or at least 40 m²/g, or at least 45 m²/g, or at least 50 m²/g, or at least 55 m²/g, or at least 60 m²/g, or at least 65 m²/g, or at least 70 m²/g, or at least 75 m²/g, or at least 80 m²/g, or at least 85 m²/g, or at least 90 m²/g, or at least 95 m²/g, or at least 100 m²/g, or at least 150 m²/g, or at least 200 m²/g, or at least 250 m²/g, or at least 300 m²/g, or at least 350 m²/g, or at least 400 m²/g, or at least 450 m²/g, or at least 500 m²/g, or at least 550 m²/g, or at least 600 m²/g, or at least 650 m²/g, or at least 700 m²/g, or at least 750 m²/g, or at least 800 m²/g, or at least 850 m²/g, or at least 900 m²/g, or at least 950 m²/g, or at least 1000 m²/g, or at least 1500 m²/g, or at least 2000 m²/g, or at least 2500 m²/g, or at least 3000 m²/g, or at least 3500 m²/g, or at least 4000 m²/g, or at least 4500 m²/g, or at least 5000 m²/g, or at least 5500 m²/g, or at least 6000 m²/g, or at least 6500 m²/g, or at least 7000 m²/g, or at least 7500 m²/g, or at least 8000 m²/g, or at least 8500 m²/g, or at least 9000 m²/g, or at least 9500 m²/g, or at least 10000 m²/g, or at least 15000 m²/g, or at least 20000 m²/g, or at least 25000 m²/g, or at least 30000 m²/g, or at least 35000 m²/g, or at least 40000 m²/g, or at least 45000 m²/g, or at least 50000 m²/g, or at least 55000 m²/g, or at least 60000 m²/g, or at least 65000 m²/g, or at least 70000 m²/g, or at least 75000 m²/g, or at least 80000 m²/g, or at least 85000 m²/g, or at least 90000 m²/g, or at least 95000 m²/g, or at least 100000 m²/g.

In an embodiment, said porous material may be a material having a specific surface area below 200000 m²/g, or below 150000 m²/g, or below 100000 m²/g, or below 95000 m²/g, or below 90000 m²/g, or below 85000 m²/g, or below 80000 m²/g, or below 75000 m²/g, or below 70000 m²/g, or below 65000 m²/g, or below 60000 m²/g, or below 55000 m²/g, or below 50000 m²/g, or below 45000 m²/g, or below 40000 m²/g, or below 35000 m²/g, or below 30000 m²/g, or below 25000 m²/g, or below 20000 m²/g, or below 15000 m²/g, or below 10000 m²/g, or below 9500 m²/g, or below 9000 m²/g, or below 8500 m²/g, or below 8000 m²/g, or below 7500 m²/g, or below 7000 m²/g, or below 6500 m²/g, or below 6000 m²/g, or below 5500 m²/g, or below 5000 m²/g, or below 4500 m²/g, or below 4000 m²/g, or below 3500 m²/g, or below 3000 m²/g, or below 2500 m²/g, or below 2000 m²/g, or below 1500 m²/g, or below 1000 m²/g, or below 950 m²/g, or below 900 m²/g, or below 850 m²/g, or below 800 m²/g, or below 750 m²/g, or below 700 m²/g, or below 650 m²/g, or below 600 m²/g, or below 550 m²/g, or below 500 m²/g, or below 450 m²/g, or below 400 m²/g, or below 350 m²/g, or below 300 m²/g, or below 250 m²/g, or below 200 m²/g, or below 150 m²/g, or below 100 m²/g. Optionally, a porous material used in a method according to this embodiment has at least a given specific surface area, as described herein.

In an embodiment, said porous material may be a material having a specific surface area from 10 m²/g up to 10000 m²/g, optionally from 100 m²/g up to 3000 m²/g, optionally from 200 m²/g up to 2000 m²/g.

The adsorption of a molecule to a (porous) material is the adhesion of said molecule to the surface of said (porous) material. It is understood that said surface may be an inner surface of said material such as the surface outlining a pore comprised in a porous material, or said surface may be an outer surface of said material. Optionally, adsorption refers to the adhesion of carbon dioxide. Adhesion may occur via chemisorption and/or physisorption. In the context of this application, adsorption “to a (porous) material”, “in a (porous) material” and “onto a (porous) material” may be used interchangeably.

A (porous) material may be characterised by a certain carbon dioxide adsorption capacity. The carbon dioxide adsorption capacity of a material is the maximum amount of carbon dioxide that can be adsorbed to said material at a given temperature. Optionally, the carbon dioxide adsorption capacity of a material is expressed as the number of carbon dioxide molecules which can (maximally) be adsorbed to a gram of said material. The carbon dioxide adsorption capacity of a porous material used in a method according to the invention may be measured by increasing the carbon dioxide (partial) pressure until a saturation adsorption is reached. Optionally, the carbon dioxide adsorption capacity is determined at a temperature of 298 Kelvin.

In an embodiment, said porous material may have a carbon dioxide adsorption capacity of at least 0.1 millimol (carbon dioxide) per gram (of said porous material), or at least 0.2 millimol per gram, or at least 0.3 millimol per gram, or at least 0.4 millimol per gram, or at least 0.5 millimol per gram, or at least 0.6 millimol per gram, or at least 0.7 millimol per gram, or at least 0.8 millimol per gram, or at least 0.9 millimol per gram, or at least 1 millimol per gram, or at least 1.5 millimol per gram, or at least 2 millimol per gram, or at least 2.5 millimol per gram, or at least 3 millimol per gram, or at least 3.5 millimol per gram, or at least 4 millimol per gram, or at least 4.5 millimol per gram, or at least 5 millimol per gram, or at least 5.5 millimol per gram, or at least 6 millimol per gram, or at least 6.5 millimol per gram, or at least 7 millimol per gram, or at least 7.5 millimol per gram, or at least 8 millimol per gram, or at least 8.5 millimol per gram, or at least 9 millimol per gram, or at least 9.5 millimol per gram, or at least 10 millimol per gram, or at least 10 millimol per gram, or at least 11 millimol per gram, or at least 12 millimol per gram, or at least 13 millimol per gram, or at least 14 millimol per gram, or at least 15 millimol per gram, or at least 16 millimol per gram, or at least 17 millimol per gram, or at least 18 millimol per gram, or at least 19 millimol per gram, or at least 20 millimol per gram at 298 Kelvin. Optionally, a porous material is used in a method according to the invention wherein said flue gas is comprised of carbon dioxide and other components within said flue gas. Optionally, said gas is high concentration carbon dioxide stream with impurities. Optionally, said gas is low carbon dioxide from air through Direct Air Capture.

In an embodiment, a porous material may have a carbon dioxide adsorption capacity lower than 100 millimol per gram, or lower than 95 millimol per gram, or lower than 90 millimol per gram, or lower than 85 millimol per gram, or lower than 80 millimol per gram, or lower than 75 millimol per gram, or lower than 70 millimol per gram, or lower than 65 millimol per gram, or lower than 60 millimol per gram, or lower than 55 millimol per gram, or lower than 50 millimol per gram, or lower than 45 millimol per gram, or lower than 40 millimol per gram, or lower than 35 millimol per gram, or lower than 30 millimol per gram, or lower than 25 millimol per gram, or lower than 20 millimol per gram at 298 Kelvin. Optionally, a porous material used in a method according to this embodiment has at least a given carbon dioxide capacity as described herein. Optionally, said porous material is used in a method according to the invention wherein said flue gas is comprised of carbon dioxide and other components within said flue gas. Optionally, said gas is high concentration carbon dioxide stream with impurities. Optionally, said gas is low carbon dioxide from air through Direct Air Capture.

In an embodiment, said porous material has a carbon dioxide adsorption capacity from 0.1 millimol per gram up to 100 millimol per gram, optionally from 1 millimol per gram up to 10 millimol per gram.

A (porous) material may be further characterised by a certain carbon dioxide affinity. The carbon dioxide affinity of a material is the ease of adsorption of carbon dioxide to said material at a given temperature. Optionally, the carbon dioxide adsorption capacity of a material is expressed as the first-order rate constant of the adsorption curve of carbon dioxide to said material. The adsorption curve is the amount of carbon dioxide adsorbed to said material at a given temperature in function of CO2 pressure, which can easily be measured by a skilled person. As well known by the skilled person, the first-order rate constant may be determined by approximating said adsorption curve as a first-order kinetics process. It should be noted that this preferred definition of carbon dioxide affinity does not imply that the adsorption of carbon dioxide to a porous material used in a method according to the invention is essentially a first-order process. Optionally, the carbon dioxide affinity is determined at a temperature of 298 Kelvin.

In an embodiment, said porous material has a carbon dioxide affinity of at least 0.1 min⁻¹, or at least 0.2 min⁻¹, or at least 0.3 min⁻¹, or at least 0.4 min⁻¹, at least 0.5 min⁻¹, or at least 0.6 min⁻¹, or at least 0.7 min⁻¹, or at least 0.8 min⁻¹, or at least 0.9 min⁻¹, or at least 1 min⁻¹, or at least 1.5 min⁻¹, or at least 2 min⁻¹, or at least 2.5 min⁻¹, or at least 3 min⁻¹, or at least 3.5 min⁻¹, or at least 4 min⁻¹, or at least 4.5 min⁻¹, or at least 5 min⁻¹, or at least 5.5 min⁻¹, or at least 6 min⁻¹, or at least 6.5 min⁻¹, or at least 7 min⁻¹, or at least 7.5 min⁻¹, or at least 8 min⁻¹, or at least 8.5 min⁻¹, or at least 9 min⁻¹, or at least 9.5 min⁻¹, or at least 10 min⁻¹, or at least 10.5 min⁻¹, or at least 11 min⁻¹, or at least 11.5 min⁻¹, or at least 12 min⁻¹, or at least 12.5 min⁻¹, or at least 13 min⁻¹, or at least 13.5 min⁻¹, or at least 14 min⁻¹, or at least 14.5 min⁻¹, or at least 15 min⁻¹ at 298 Kelvin. Optionally, said gas is high concentration carbon dioxide stream with impurities. Optionally, said gas is low carbon dioxide from air through Direct Air Capture. Optionally, said gas stream is flue gases.

In an embodiment, said porous material has a carbon dioxide affinity lower than 30 min⁻¹, or lower than 29 min⁻¹, or lower than 28 min⁻¹, or lower than 27 min⁻¹, or lower than 26 min⁻¹, or lower than 25 min⁻¹, or lower than 24 min⁻¹, or lower than 23 min⁻¹, or lower than 22 min⁻¹, or lower than 21 min⁻¹, or lower than 20 min⁻¹, or lower than 19 min⁻¹, or lower than 18 min⁻¹, or lower than 17 min⁻¹, or lower than 16 min⁻¹, or lower than 15 min⁻¹ at 298 Kelvin. Optionally, a porous material used in method according to this embodiment has at least a given carbon dioxide affinity as described herein. Optionally, said gas is high concentration carbon dioxide stream with impurities. Optionally, said gas is low carbon dioxide from air through Direct Air Capture. Optionally, said gas stream is flue gases.

In an embodiment, said porous material has a carbon dioxide affinity from 0.5 min⁻¹ up to 20 min⁻¹, optionally from 1 min⁻¹ up to 10 min⁻¹. Optionally, said gas is high concentration carbon dioxide stream with impurities. Optionally, said gas is low carbon dioxide from air through Direct Air Capture. Optionally, said gas stream is flue gases.

The carbon dioxide adsorption selectivity of a porous material used in a method according to the invention is defined as the ratio of the total number of carbon dioxide molecules adsorbed to said porous material at the end of the sorption step to the total number of molecules of said gas adsorbed to said porous material at the end of the sorption step. The carbon dioxide adsorption selectivity of a material is also called the carbon dioxide adsorption selectivity of said material in said gas stream.

In an embodiment, the carbon dioxide adsorption selectivity of said porous material may be at least 0.01, or at least 0.02, or at least 0.03, or at least 0.04, or at least 0.05, or at least 0.06, or at least 0.07, or at least 0.08, or at least 0.09, or at least 0.1, or at least 0.2, or at least 0.3, or at least 0.4, or at least 0.5, or at least 0.6, or at least 0.7, or at least 0.8, or at least 0.9, or at least 1, or at least 2, or at least 3, or at least 4, or at least 5, or at least 6, or at least 7, or at least 8, or at least 9, or at least 10, or at least 15, or at least 20, or at least 25, or at least 30, or at least 35, or at least 40, or at least 45, or at least 50, or at least 55, or at least 60, or at least 65, or at least 70, or at least 75, or at least 80, or at least 85, or at least 90, or at least 95, or at least 100. Optionally, said gas is high concentration carbon dioxide stream with impurities. Optionally, said gas is low carbon dioxide from air through Direct Air Capture. Optionally, said gas stream is flue gases.

In an embodiment, the carbon dioxide adsorption selectivity of said porous material may be lower than 300, or lower than 290, or lower than 280, or lower than 270, or lower than 260, or lower than 250, or lower than 240, or lower than 230, or lower than 220, or lower than 210, or lower than 200, or lower than 190, or lower than 180, or lower than 170, or lower than 160, or lower than 150, or lower than 140, or lower than 130, or lower than 120, or lower than 110, or lower than 100, or lower than 95, or lower than 90, or lower than 85, or lower than 80, or lower than 75, or lower than 70, or lower than 65, or lower than 60, or lower than 55, or lower than 50, or lower than 45, or lower than 40, or lower than 35, or lower than 30, or lower than 25, or lower than 20, or lower than 15, or lower than 10, or lower than 9, or lower than 8, or lower than 7, or lower than 6, or lower than 5, or lower than 4, or lower than 3, or lower than 2, or lower than 1. Optionally, said gas is high concentration carbon dioxide stream with impurities. Optionally, said gas is low carbon dioxide from air through Direct Air Capture. Optionally, said gas stream is flue gases.

In an embodiment, the carbon dioxide adsorption selectivity of said porous material is from 0.1 up to 200, optionally from 1 up to 30. Optionally, said gas is high concentration carbon dioxide stream with impurities. Optionally, said gas is low carbon dioxide from air through Direct Air Capture. Optionally, said gas stream is flue gases.

In an embodiment, a porous material may be defined as a selective carbon dioxide adsorber (in said gas mixture) if the carbon dioxide selectivity of said porous material in said gas mixture is at least 0.01, or at least 0.02, or at least 0.03, or at least 0.04, or at least 0.05, or at least 0.06, or at least 0.07, or at least 0.08, or at least 0.09, or at least 0.1, or at least 0.2, or at least 0.3, or at least 0.4, or at least 0.5, or at least 0.6, or at least 0.7, or at least 0.8, or at least 0.9, or at least 1, or at least 2, or at least 3, or at least 4, or at least 5, or at least 6, or at least 7, or at least 8, or at least 9, or at least 10, or at least 15, or at least 20, or at least 25, or at least 30, or at least 35, or at least 40, or at least 45, or at least 50, or at least 55, or at least 60, or at least 65, or at least 70, or at least 75, or at least 80, or at least 85, or at least 90, or at least 95, or at least 100. Optionally, said gas is high concentration carbon dioxide stream with impurities. Optionally, said gas is low carbon dioxide from air through Direct Air Capture. Optionally, said gas stream is flue gases. In a preferred definition, said selective carbon dioxide adsorber is further characterized in that said the carbon dioxide adsorption selectivity of said porous material is lower than 300, or lower than 290, or lower than 280, or lower than 270, or lower than 260, or lower than 250, or lower than 240, or lower than 230, or lower than 220, or lower than 210, or lower than 200, or lower than 190, or lower than 180, or lower than 170, or lower than 160, or lower than 150, or lower than 140, or lower than 130, or lower than 120, or lower than 110, or lower than 100, or lower than 95, or lower than 90, or lower than 85, or lower than 80, or lower than 75, or lower than 70, or lower than 65, or lower than 60, or lower than 55, or lower than 50, or lower than 45, or lower than 40, or lower than 35, or lower than 30, or lower than 25, or lower than 20, or lower than 15, or lower than 10, or lower than 9, or lower than 8, or lower than 7, or lower than 6, or lower than 5, or lower than 4, or lower than 3, or lower than 2, or lower than 1.

In an embodiment, said porous material may be a selective carbon dioxide adsorber, and the carbon dioxide adsorption selectivity of said material in said gas mixture is at least 0.01, or at least 0.02, or at least 0.03, or at least 0.04, or at least 0.05, or at least 0.06, or at least 0.07, or at least 0.08, or at least 0.09, or at least 0.1, or at least 0.2, or at least 0.3, or at least 0.4, or at least 0.5, or at least 0.6, or at least 0.7, or at least 0.8, or at least 0.9, or at least 1, or at least 2, or at least 3, or at least 4, or at least 5, or at least 6, or at least 7, or at least 8, or at least 9, or at least 10, or at least 15, or at least 20, or at least 25, or at least 30, or at least 35, or at least 40, or at least 45, or at least 50, or at least 55, or at least 60, or at least 65, or at least 70, or at least 75, or at least 80, or at least 85, or at least 90, or at least 95, or at least 100. Optionally, the carbon dioxide adsorption selectivity of said material in said liquid is lower than 300, or lower than 290, or lower than 280, or lower than 270, or lower than 260, or lower than 250, or lower than 240, or lower than 230, or lower than 220, or lower than 210, or lower than 200, or lower than 190, or lower than 180, or lower than 170, or lower than 160, or lower than 150, or lower than 140, or lower than 130, or lower than 120, or lower than 110, or lower than 100, or lower than 95, or lower than 90, or lower than 85, or lower than 80, or lower than 75, or lower than 70, or lower than 65, or lower than 60, or lower than 55, or lower than 50, or lower than 45, or lower than 40, or lower than 35, or lower than 30, or lower than 25, or lower than 20, or lower than 15, or lower than 10, or lower than 9, or lower than 8, or lower than 7, or lower than 6, or lower than 5, or lower than 4, or lower than 3, or lower than 2, or lower than 1. Optionally, the carbon dioxide adsorption selectivity of said material in said liquid is from 0.1 up to 200, optionally from 1 up to 30. Optionally, said gas is high concentration carbon dioxide stream with impurities. Optionally, said gas is low carbon dioxide from air through Direct Air Capture. Optionally, said gas stream is flue gases.

In an embodiment, said porous material may comprise one or more of porous carbons and zeolites, optionally wherein said porous material has a specific surface area of at least 1000 m²/g, optionally at least 3000 m²/g; and/or optionally wherein said porous material has a carbon dioxide adsorption capacity of at least 0.4 millimol per gram at 298 Kelvin; and/or optionally wherein said porous material has a carbon dioxide affinity of at least 1 min-1, optionally 5 min⁻¹ at 298 Kelvin; and/or, optionally wherein said porous material is a selective carbon dioxide adsorber in said liquid; and/or, optionally wherein said porous material comprises at least 1 acid or basic site per 100 carbon dioxide adsorption sites, optionally at least 1 acid or basic site per 20 carbon dioxide adsorption sites; and/or, optionally wherein said gas stream is flue gas, high purity carbon dioxide or direct air capture stream.

In an embodiment, said porous material may comprise one or more of carbon black, activated carbons, silicalite-1, H-ZSM-5, faujasite, mordenite, zeolite beta, optionally wherein said porous material has a specific surface area of at least 500 m²/g, optionally at least 3000 m²/g up to 6000 m²/g and optionally up to 10,000 m²/g; and/or, optionally wherein said porous material has a carbon dioxide adsorption capacity of at least 0.4 millimol per gram at 298 Kelvin; and/or, optionally wherein said porous material has a carbon dioxide affinity of at least 1 min⁻¹, optionally 5 min⁻¹ at 298 Kelvin; and/or, optionally wherein said porous material is a selective carbon dioxide adsorber in said liquid; and/or, optionally wherein said porous material comprises at least 1 acid or basic site per 100 carbon dioxide adsorption sites, optionally at least 1 acid or basic site per 20 carbon dioxide adsorption sites; and/or, optionally, said gas is high concentration carbon dioxide stream with impurities. Optionally, said gas is low carbon dioxide from air through Direct Air Capture. Optionally, said gas stream is flue gases.

In an embodiment, said porous material may be a porous carbon, optionally wherein said porous material has a specific surface area of at least 1000 m²/g, optionally at least 3000 m²/g; and/or, optionally wherein said porous material has a carbon dioxide adsorption capacity of at least 1 millimol per gram at 298 Kelvin; and/or, optionally wherein said porous material has a carbon dioxide affinity of at least 1 min⁻¹, optionally 5 min⁻¹ at 298 Kelvin; and/or, optionally wherein said porous material is a selective carbon dioxide adsorber in said gas; and/or, optionally wherein said porous material comprises at least 1 acid or basic site per 100 carbon dioxide adsorption sites, optionally at least 1 acid or basic site per 20 carbon dioxide adsorption sites; and/or, Optionally, said gas is high concentration carbon dioxide stream with impurities. Optionally, said gas is low carbon dioxide from air through Direct Air Capture. Optionally, said gas stream is flue gases.

In an embodiment, said porous material may be an activated carbon, optionally wherein said porous material has a specific surface area of at least 1000 m²/g, optionally at least 3000 m²/g; and/or, optionally wherein said porous material has a carbon dioxide adsorption capacity of at least 0.8 millimol per gram at 298 Kelvin; and/or, optionally wherein said porous material has a carbon dioxide affinity of at least 1 min-1, optionally 5 min-1 at 298 Kelvin; and/or, optionally wherein said porous material is a selective carbon dioxide adsorber in said gas mixture; and/or, optionally wherein said porous material comprises at least 1 acid or basic site per 100 carbon dioxide adsorption sites, optionally at least 1 acid or basic site per 20 carbon dioxide adsorption sites; and/or, Optionally, said gas is high concentration carbon dioxide stream with impurities. Optionally, said gas is low carbon dioxide from air through Direct Air Capture. Optionally, said gas stream is flue gases.

In an embodiment, said porous material may comprise one or more of zeolites, porous aluminosilicate polymorphs, activated carbons, carbon black, porous polymer networks, porous inorganic oxides, metal-organic-frameworks, zeolitic imidazolate frameworks, silicates, diethanolamine (DEA) upon an acrylic ester polymer resin, tetraethylenepentaamineacrylonitrile (TEPAN) upon non-ionic, polymeric polmethylmethacrylate (PMMA) beads, aminopropyltriethoxysilane bonded to silica gel, polyethylenimine (PEI) and polyethylene glycol (PEG) impregnated onto the surface of low cost fly ash derived carbons, PEI immobilised on a mesoporous silica support and polyoligosiloxysilicones, optionally wherein said porous material has a specific surface area of at least 100 m²/g, optionally at least 1000 m²/g; and/or, optionally wherein said porous material has a carbon dioxide adsorption capacity of at least 0.4 millimol per gram at 298 Kelvin; and/or, optionally wherein said porous material has a carbon dioxide affinity of at least 1 min⁻¹, optionally 5 min-1 at 298 Kelvin; and/or, optionally wherein said porous material is a selective carbon dioxide adsorber in said liquid; and/or, optionally wherein said porous material comprises at least 1 acid or basic site per 100 carbon dioxide adsorption sites, optionally at least 1 acid or basic site per 20 carbon dioxide adsorption sites; and/or, Optionally, said gas is high concentration carbon dioxide stream with impurities. Optionally, said gas is low carbon dioxide from air through Direct Air Capture. Optionally, said gas stream is flue gases.

In an embodiment, said porous material may comprise one or more of activated carbons and zeolites, optionally wherein said porous material has a specific surface area of at least 1000 m²/g, optionally at least 3000 m²/g; and/or, optionally wherein said porous material has a carbon dioxide adsorption capacity of at least 0.4 millimol per gram at 298 Kelvin; and/or, optionally wherein said porous material has a carbon dioxide affinity of at least 1 min⁻¹, optionally 5 min⁻¹ at 298 Kelvin; and/or, optionally wherein said porous material is a selective carbon dioxide adsorber in said liquid; and/or, optionally wherein said porous material comprises at least 1 acid or basic site per 100 carbon dioxide adsorption sites, optionally at least 1 acid or basic site per 20 carbon dioxide adsorption sites; and/or, Optionally, said gas is high concentration carbon dioxide stream with impurities. Optionally, said gas is low carbon dioxide from air through Direct Air Capture. Optionally, said gas stream is flue gases.

In an embodiment, said porous material is a composite material.

In an embodiment, said porous material is not a membrane.

In an embodiment, said porous material comprises an acid or basic site. In a more preferred embodiment is provided a method according to the invention wherein said porous material comprises at least 1 acid or basic sites per 90 carbon dioxide adsorption sites, per 80 carbon dioxide adsorption sites, per 70 carbon dioxide adsorption sites, per 60 carbon dioxide adsorption sites, per 50 carbon dioxide adsorption sites, per 40 carbon dioxide adsorption sites, per 30 carbon dioxide adsorption sites, per 20 carbon dioxide adsorption sites, per 10 carbon dioxide adsorption sites, per 10 carbon dioxide adsorption sites, per 9 carbon dioxide adsorption sites, per 8 carbon dioxide adsorption sites, per 7 carbon dioxide adsorption sites, per 6 carbon dioxide adsorption sites, per 5 carbon dioxide adsorption sites, per 4 carbon dioxide adsorption sites, per 3 carbon dioxide adsorption sites, per 2 carbon dioxide adsorption sites, or per 1 carbon dioxide adsorption site. An acid or basic site is a group comprised in a material which is able to catalyze an acid-base reaction. Said acid-base reaction may be a Brønsted acid-base reaction of a Lewis acid-base reaction. Optionally, said acid or basic site catalyzes the conversion of one compound selected from the group consisting of CO₂, H₂CO₃, HCO₃—, CO₃ 2— into another compound selected from said group. A carbon dioxide adsorption site, as well known to the skilled person, is a specific part of said porous material to which a carbon dioxide molecule is able to adsorb. Herein, it is understood that other types of compounds may be able to adsorb to a carbon dioxide adsorption site.

In an embodiment, said porous material does not comprise more than 1 acid or basic site per 20 carbon dioxide adsorption sites, per 30 carbon dioxide adsorption sites, per 40 carbon dioxide adsorption sites, per 50 carbon dioxide adsorption sites, per 60 carbon dioxide adsorption sites, per 70 carbon dioxide adsorption sites, per 80 carbon dioxide adsorption sites, per 90 carbon dioxide adsorption sites, or per 100 carbon dioxide adsorption sites. Optionally, a porous material used in a method according to this embodiment comprises at least a number of acid or basic sites as described herein.

In an embodiment, said porous material comprise from 1 acid or basic site per 20 carbon dioxide adsorption sites up to 1 acid or basic site per 100 carbon dioxide adsorption sites.

Gaseous carbon dioxide refers to a carbon dioxide molecule in a gas phase.

The concrete mix may comprise cement type 1. The concrete mix may comprise one or more of ground granulated blast furnace slag and fly ash. The use of industrial byproducts, such as ground granulated blast furnace slag and fly ash, may be used to reduce the amount of cement needed in the concrete mix, thereby in turn reducing greenhouse gas emissions caused by the production of cement.

Further according to the invention, there is provided use of the method according to the first aspect of the invention to sequester greenhouse gas carbon dioxide and/or to increase the strength of concrete material.

Further according to the invention, there is provided an apparatus for the preparation of a concrete material prepared by the method according to the first aspect of the invention, comprising a reactor which comprises:
a first inlet for carbon dioxide;
a second inlet for the carrier; and
an outlet for the carrier comprising adsorbed carbon dioxide formed in the reactor;
wherein the outlet optionally feeds the carrier comprising adsorbed carbon dioxide into a second reactor for containment of the concrete mix. Optionally, the carrier comprising of the adsorbed carbon dioxide feeds into secondary containment for transportation and usage at different times or sites.

In an embodiment, said apparatus has a fluidised bed reactor. Herein, it is understood that said sorption step takes place in the reactor comprised in said apparatus. Optionally, an apparatus according to this embodiment comprises a sealable compartment, optionally wherein said sealable compartment comprises said porous material.

In an embodiment, said apparatus has a stirred tank reactor. Herein, it is understood that said sorption step takes place in the reactor comprised in said apparatus. Optionally, an apparatus according to this embodiment comprises a sealable compartment, optionally wherein said sealable compartment comprises said porous material.

In an embodiment, said apparatus has a fixed bed reactor. Herein, it is understood that said sorption step takes place in the reactor comprised in said apparatus. Optionally, an apparatus according to this embodiment comprises a sealable compartment, optionally wherein said sealable compartment comprises said porous material.

In an embodiment, an apparatus for performing a method for extracting carbon dioxide from a gas stream according to any of the embodiments provided above. Specifically, the invention provides an apparatus comprising a porous material, wherein said apparatus may be used for performing a method for extracting carbon dioxide from a gas stream, wherein said method comprises an extraction cycle and delivery cycle. A specific methodology for the delivery and release of CO₂ into concrete implemented to maximise the reaction of CO₂ with concrete, allowing the optimum reaction of calcium hydroxide with the CO₂ to form calcium carbonate. This reaction enhances the mechanical properties of concrete, including the enhancement of compressive strength, durability and reduction of porosity. As a result of the enhanced mechanical properties, the cement content of concrete can be reduced significantly. This allows the reduction of the overall carbon footprint of concrete through direct sequestration and/or material reduction. Wherein said extraction cycle comprises (i) a sorption step wherein carbon dioxide in said gas stream is adsorbed to a porous material, wherein said porous material contacts said gas stream; and (ii) a desorption step wherein said adsorbed carbon dioxide obtained at the end of said sorption step is released from said porous material as gaseous carbon dioxide to carbonate concrete; Said apparatus is referred to as an apparatus of or according to the invention in the context of this application.

In an embodiment, said apparatus comprises a sealable compartment for adsorption. If an apparatus according to this embodiment is used for performing a method according to the invention, during the adsorption step said sealable compartment is sealed and said sealed department comprises said porous material. In an embodiment, said apparatus comprises a sealable compartment, wherein said sealable compartment comprises said porous material.

Direct Air Capture (DAC), flue gas and pure CO₂ from various sources (CO₂ concentration between 0.04-99.9%) is injected into the reactor containing the (carrier) described porous media below. Carrier adsorbs specific amount of CO₂ at designed temperature and pressure. In one variation the excess gas is compressed above the pressure of the reactor and is recycled to the reactor. The CO₂ loaded carrier is transferred to the concrete at the specified pressure. It is mixed into the concrete. The release can be controlled through diffusion based on loading, pH, temperature, mixing and pressure and particle size triggers. In this way, the concentration of carbon dioxide delivered into the concrete mix and the rate of release of carbon dioxide into the concrete mix can be managed.

The invention further provides the use of an apparatus according to the invention, or according to any preferred embodiment described above.

In this document and in its claims, the verb “to comprise” and its conjugations is used in its non-limiting sense to mean that items following the word are included, but items not specifically mentioned are not excluded. In addition the verb “to consist” may be replaced by “to consist essentially of” meaning that a method or an apparatus as defined herein may comprise additional steps or component(s) than the ones specifically identified, said additional component(s) not altering the unique characteristic of the invention. In addition, reference to an element by the indefinite article “a” or “an” does not exclude the possibility that more than one of the elements is present, unless the context clearly requires that there be one and only one of the elements. The indefinite article “a” or “an” thus usually means “at least one”.

Each embodiment as identified herein may be combined together unless otherwise indicated. All patent and literature references cited in the present specification are hereby incorporated by reference in their entirety.

In the context of this invention “identical” should not be so narrowly construed as to imply that the natural abundance of isotopes should be contemplated—identical should preferably only refer to the molecular structure as would be represented in a drawn structural formula.

In the context of this invention, a decrease or increase of a parameter to be assessed means a change of at least 5% of the value corresponding to that parameter. More preferably, a decrease or increase of the value means a change of at least 10%, even more preferably at least 20%, at least 30%, at least 40%, at least 50%, at least 70%, at least 90%, or 100%. In this latter case, it can be the case that there is no longer a detectable value associated with the parameter.

The word “about” or “approximately” when used in association with a numerical value (e.g. about 10) preferably means that the value may be the given value (of 10) more or less 0.1% of the value.

The proposition “between” when used in association with integers refers to a range including the boundary values mentioned. For example, if n is a value between 1 and 3, n may be 1, 2 or 3. In other words, “between X and Y” is a synonym of “from X up to Y”.

In the context of this invention, “represented by structure X”, “of structure X” and “with structure X” are used interchangeably.

An experiment may be any type of experiment in the context of this application, including a wet lab or in vitro experiment, and an in silico or computational experiment. Hence, experimental results are meant to encompass computational results.

A first system contacts a second system if a significant part of the outer surface of said first system contacts with said second system. Optionally, said significant part of the outer surface is at least 50%, or at least 55%, or at least 60%, or at least 65%, or at least 70%, or at least 75%, or at least 80%, or at least 85%, or at least 90%, or at least 95%, or 100% of said outer surface. For example, a porous material contacts a liquid or gas if it is partially or fully immersed in said liquid or gas, optionally wherein partially means that at least 50%, or at least 55%, or at least 60%, or at least 65%, or at least 70%, or at least 75%, or at least 80%, or at least 85%, or at least 90%, or at least 95% of the outer surface of said porous material contacts said liquid or gas.

Embodiments of methods and structures in accordance with the invention will now be described with reference to the accompanying drawings, in which:

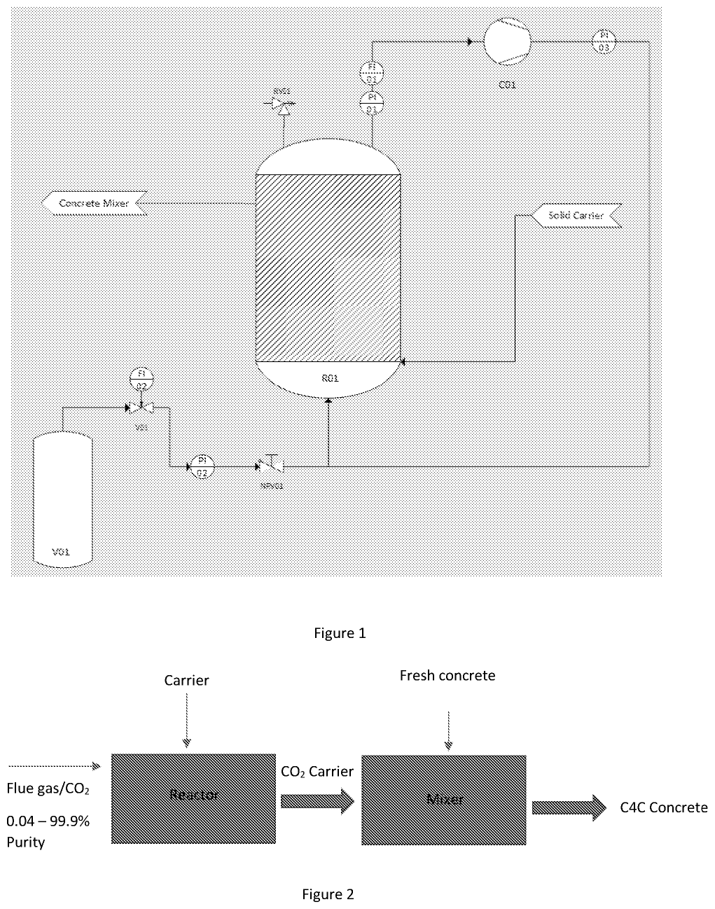

FIG. 1 shows a schematic representation of an embodiment of an apparatus of the invention.

FIG. 2 shows a schematic representation of an embodiment of a method of the invention.

FIG. 1 shows how carbon dioxide from a carbon dioxide source (V01) is delivered into the reactor (R01) via a first inlet and a solid carrier is delivered into the reactor via a second inlet. The first inlet comprises a pressure sensor (P1) to determine the pressure of carbon dioxide in the first inlet.

The carbon dioxide becomes adsorbed on the carrier within the reactor. The carrier comprising adsorbed carbon dioxide may then pass through an outlet and into a second reactor for containing the concrete mix.

The carrier may be weighed before and after adsorption of carbon dioxide in order to determine how much carbon dioxide has been adsorbed onto the carrier. In this way, the carrier comprising the adsorbed carbon dioxide can be used to deliver a known and predetermined quantity of carbon dioxide into the concrete mix. The concrete mix comprises cement and aggregate, and therefore the carrier herebefore defined does not replace the aggregate in the concrete mix. The mixture of concrete and carrier is therefore defined as the concrete-carrier mix.

FIG. 2 shows how carbon dioxide, such as from flue gases, is mixed with the carrier in a reactor. The carrier comprising adsorbed carbon dioxide is mixed with fresh concrete in the mixer to form the C4C (concrete 4 change) concrete containing the sequestered carbon dioxide.

Various examples of possible carriers have been tested.

### Example 1

Carbon dioxide >99% transfer with activated carbon and concrete mix (cement type 1).

In this example 50 g activated carbon was weighed. It was processed and transferred to the fluidised bed reactor.

Carbon dioxide from a pressurised cylinder was passed over 50 g of activated carbon at 2 bara.

The fluidised bed was depressurized, the activated carbon moved into a reweighted container. The weight difference was recorded showing 0.176 g/g of activated carbon.

A concrete mix including 100% cement type 1 binder and a water to binder ratio of 0.5 was prepared.

The activated carbon was mixed into the concrete mix.

The strength of concrete (7 day, 14 day, 28 day) was measured showing a 20-45% increase in strength.

The plasticity of fresh concrete exhibited very limited changes.

The durability and PH of concrete exhibited very limited change.

### Example 2

Carbon dioxide >99% transfer with activated carbon and concrete mix (cement type 1 and ground granulated blast-furnace slag)

In this example 50 g activated carbon was weighed. It was processed and transferred to the fluidised bed reactor.

Carbon dioxide from a pressurised cylinder was passed over 50 g of activated carbon at 2 bara.

The fluidised bed was depressurised, the activated carbon moved into a reweighted container. The weight difference was recorded showing 0.176 g/g of activated carbon.

A concrete mix including 50% cement type 1 and 50% Ground Granulated Blast-furnace Slag binder and water to binder ratio of 0.5 was prepared.

The activated carbon was mixed into the concrete mix.

The strength of concrete (7 day, 14 day, 28 day) was measured showing an 18-41% increase in strength.

The plasticity of fresh concrete exhibited very limited changes.

The durability and PH of concrete exhibited very limited change.

### Example 3

Carbon dioxide >99% transfer with activated carbon and concrete mix (cement type 1 and fly ash)

In this example 50 g activated carbon was weighed. It was processed and transferred to the fluidised bed reactor.

Carbon dioxide from a pressurised cylinder was passed over 50 g of activated carbon at 2 bara.

The fluidised bed was depressurised, the activated carbon moved into a reweighted container. The weight difference was recorded showing 0.176 g/g of activated carbon.

A concrete mix including 50% cement type 1 and 50% fly ash binder and water to binder ratio of 0.5 was prepared.

The activated carbon was mixed into the concrete mix.

The strength of concrete (7 day, 14 day, 28 day) was measured showing a 17-42% increase in strength.

The plasticity of fresh concrete exhibited very limited changes.

The durability and PH of concrete exhibited very limited change.

### Example 4

Carbon dioxide >30% synthetic mix gas transfer with activated carbon and concrete mix (cement type 1)

In this example 50 g activated carbon was weighed. It was processed and transferred to the fluidised bed reactor.

Carbon dioxide from a pressurised cylinder was passed over 50 g of activated carbon at 3.5 bara.

The fluidised bed was depressurised, the activated carbon moved into a reweighted container. The weight difference was recorded showing 0.168 g/g of activated carbon.

A concrete mix including 100% cement type 1 binder and water to binder ratio of 0.5 was prepared.

The activated carbon was mixed into the concrete mix.

The strength of concrete (7 day, 14 day, 28 day) was measured showing a 19-44% increase in strength.

The plasticity of fresh concrete exhibited very limited changes.

The durability and PH of concrete exhibited very limited change.

### Example 5

Carbon dioxide >30% synthetic mix gas transfer with activated and concrete mix (cement type 1 and ground granulated blast-furnace slag)

In this example 50 g activated carbon was weighed. It was processed and transferred to the fluidised bed reactor.

Carbon dioxide from a pressurised cylinder was passed over 50 g of activated carbon at 3.5 bara.

The fluidised bed was depressurised, the activated carbon moved into a reweighted container. The weight difference was recorded showing 0.168 g/g of activated carbon.

A concrete mix including 50% cement type 1 and 50% Ground Granulated Blast-furnace Slag binder and water to binder ratio of 0.5 was prepared.

The activated carbon was mixed into the concrete mix.

The strength of concrete (7 day, 14 day, 28 day) was measured showing a 19-38% increase in strength.

The plasticity of fresh concrete exhibited very limited changes.

The durability and PH of concrete exhibited very limited change.

### Example 6

Carbon dioxide >30% synthetic mix gas transfer with activated and concrete mix (cement type 1 and fly ash)

In this example 50 g activated carbon was weighed. It was processed and transferred to the fluidised bed reactor.

Carbon dioxide from a pressurised cylinder was passed over 50 g of activated carbon at 3.5 bara.

The fluidised bed was depressurised, the activated carbon moved into a reweighted container. The weight difference was recorded showing 0.168 g/g of activated carbon.

A concrete mix including 50% cement type 1 and 50% fly ash binder and water to binder ratio of 0.5 was prepared.

The activated carbon was mixed into the concrete mix.

The strength of concrete (7 day, 14 day, 28 day) was measured showing a 16-41% increase in strength.

The plasticity of fresh concrete exhibited very limited changes.

The durability and PH of concrete exhibited very limited change.

### Example 7

In one broad exemplary class of possible carriers is activated carbon. Activated carbon can be thermally and/or chemically reactivated using an activating agent, such as a metal hydroxide or metal salt, for example potassium hydroxide, sodium hydroxide, magnesium hydroxide, magnesium chloride, ammonium chloride, zinc chloride, potassium carbonate, sodium carbonate, potassium tetraborate, potassium oxalate, potassium phosphate, or acids such as nitric acid, phosphoric acid, or hydrochloric acid. The activating agent develops pore structure and facilitates carbon dioxide uptake by additional formation of carbonates between carbon dioxide and residual metal and/or metal hydroxide and/or metal oxide present after chemical treatment.

The modified carrier comprises activated carbon having a specific surface area of at least 500 m²/g, optionally at least 1000 m²/g, optionally at least 2000 m²/g up to 6000 m²/g and optionally up to 10,000 m²/g measured by nitrogen adsorption equipment.

The reactivation methodology is preferably performed according to known reactivation conditions, including modifying activated carbon to activating agent ratio, temperature, inert gas flow rate, and wash process, so as to yield optimum carbon dioxide adsorption capacity.

Exemplary reaction conditions may include a weight ratio of 1:1, 1:2, 1:3, 1:4, 2:1, 3:1, 4:1 of activated carbon and activating agent, or any ratio between 4:1 and 1:4.

A mixing time of activated carbon with reactivating solution until homogenous may be anywhere between 0.01 h and 48 h, and more preferably 3 h to 24 h, or an equivalent residence time.

Following mixing, the activate carbon can then be dried at an elevated temperature in the range of 30° C. to 200° C., for example, in a laboratory scale oven or equivalent. More preferably, the minimum drying temperature would be 40° C. Drying preferably occurs in sub-atmospheric pressure, that is, between 0 and 1 bara. In other words, drying may occur in a vacuum oven.

Following drying the activated carbon may be pyrolyzed at temperatures ranging from 300° C. to 950° C., and for a required amount of time ranging from 0.5 h to 24 h under inert gas, such as nitrogen or argon, at flowrates ranging from 0.05 to 1 l/min.

After reactivation, activated carbon may be unwashed, or may be washed with deionized water until the pH is in the range of 7-13. Minimising the number of washes during the preparation process has been found to assist with slow-release desorption capabilities.

### Example 7(a)

1 g of commercially available activated carbon (SK1) was mixed with potassium hydroxide solution at a 1:1 weight ratio and left for 24 h at room temperature. The solution was dried in a vacuum oven at 100° C. and 700 mbar for 16 h. The unwashed powder was pyrolyzed at 600° C. for 1 h under 1 l/min constant N₂ flow. The resulting material had a carbon dioxide capacity of 9.43 wt % measured at 25° C. after 2 h under 100 ml/min carbon dioxide flow and 1.3e-4-0.018 mmol/g/h initial release rate of up to 50% of total adsorbed carbon dioxide decelerating to 1e-10 release rate under 100 ml/min N₂ flow using thermogravimetric analyser.

### Example 7(b)

Another commercially available activated carbon (CA1) was mixed with potassium hydroxide solution at a 1:1 weight ratio and left for 24 h at room temperature. The solution was dried in a vacuum oven at 100° C. and 700 mbar for 16 h. The unwashed powder was pyrolyzed at 600° C. for 1 h. The resulting material had a carbon dioxide capacity of 3.37 wt % measured at 25° C. after 2 h under 100 ml/min carbon dioxide flow and 1.0e-4-0.001 mmol/g/h initial release rate of up to 50% of total adsorbed carbon dioxide, decelerating to 1e-10 release rate.

### Example 7(c)

Another CA1 sample was mixed with potassium hydroxide solution at a 1:2 weight ratio and left for 24 h at room temperature. The solution was dried in a vacuum oven at 100° C. and 700 mbar for 16 h. The unwashed powder was pyrolyzed at 600° C. for 1 h. The resulting material had a carbon dioxide capacity of 9.78 wt % measured at 25° C. after 2 h under 100 ml/min carbon dioxide flow and 1.7e-4-0.018 mmol/g/h, initial release rate of up to 50% of total adsorbed carbon dioxide decelerating to 1e-10 release rate under 100 ml/min N₂ flow using a thermogravimetric analyser. Carbon dioxide uptake by concrete was determined to have a rate of 0.005 mmol/g/h, as determined in a simulated concrete environment.

### Example 8

Another broad exemplary class of possible carriers is carbon with heteroatoms, preferably nitrogen. Heteroatoms can be introduced into carbon adsorbent by means of heteroatom doping into carbon structure or by impregnating or immobilising nitrogen containing compounds onto carbon surface.

Nitrogen-doped carbon can be prepared by either treating carbon, such as activated carbon, with compounds such as ammonia, nitric acid, hydrogen cyanide, urea, sodium amide, resulting in one carbon atom being substituted by nitrogen or by carbonisation of nitrogen containing compounds such as pyridine, melamine, polyaniline, followed by thermal and/or chemical activation, said nitrogen doped carbon adsorbent ensures stronger carbon dioxide-carrier interactions and increased capacity. Nitrogen containing compounds can also be impregnated or immobilised onto carbon surface. Said amino compound can be any compound comprising predominantly primary or secondary amino group, such as tetraethylenepentamine and/or polyethylenimine and/or ethanolamine, less preferably tertiary amino group, such as N-methyldiethanolamine, said support can be any form of carbon, such as activated carbon, mesoporous carbon, carbon black, fullerene, carbon nanotubes, carbon fibres.

A methodology of nitrogen doping is performed according to prior art at optimum conditions such as carbon to doping agent weight ratio, carbon precursor, pyrolysis temperature, reaction time, washing procedure that yields optimum carbon dioxide adsorption capacity. Equally, a methodology of amino compound impregnation or immobilisation is performed according to prior art at optimum conditions such as carbon to amino compound weight ratio, reaction time, temperature, stirring speed, solvent type, evaporation conditions that yields optimum amino group concentration on the surface ensuring required carbon dioxide adsorption capacity. Examples of carbon surface modification chemicals include Aminoalkyltrialkoxysilane, such as 3-Aminopropyltriethoxysilane (APTES) or similar, and/or Cyclic acid anhydrides such as Succinic anhydride, Adipic anhydride, Octenyl-succinic anhydride, and/or Branched polyethylene amines such as Tetraethylene pentaamine (TEPA) and/or Carboxylating active carbon surfaces using chemical oxidants such as 4-aminobenzoic acid (4-ABA) and/or Carbodiimide activating agents such as 1-Ethyl-3-(3-dimethylaminopropyl) carbodiimide (EDC). Other potential surface modification chemicals include cationic polymers-alkylammonium derivatives and coagulants with high charge densities (pDADMAC), Halide chelation and anionic polymer, surface organic acid functionalisation for biopolymer (CMC-carboxymethylcellulose/cellulose), use of mono-di- and tri-acid functionalities, use range of biopolymers and functional agents, use of epoxy, polymethacrylate-hydrogel and silicone based photocurable polymer resins, rapid photocuring in water and/or organic solvent MECS/other encapsulating methodologies.

### Example 9

Another broad exemplary class of possible carriers are silica support surfaces with amino compounds either impregnated or immobilized thereon. Said amino compound can be any compound comprising predominantly primary or secondary amino group, such as tetraethylenepentamine and/or, polyethylenimine, and/or ethanolamine, less preferably tertiary amino group, such as N-methyldiethanolamine, said support can be any form of silica, such as silicon dioxide, such as colloidal silica, fumed silica, silica fume, mesoporous silica, silica gel, fused silica.

The silica support has a specific surface area of at least 10 m²/g, preferably 10-4000 m²/g measured by nitrogen adsorption equipment.

The methodology of amino compound impregnation and/or immobilisation may be performed according to prior art at optimum conditions such as silica to amino compound weight ratio, reaction time, temperature, stirring speed, solvent type, evaporation conditions that yields optimum amino group concentration on the surface ensuring required CO2 adsorption capacity.

The amino impregnated and/or amino immobilised silica comprises at least required amount of amino wt % to reach required CO₂ capacity, said amino compound is at wt % to silica support at 60 wt %, or below 50 wt %, or below 40 wt %, or below 30 wt %, or below 20 wt %, or below 10 wt %, or below 5 wt %.

Examples of silica surface modification chemicals include Aminoalkyltrialkoxysilane, such as 3-Aminopropyltriethoxysilane (APTES) or similar, and/or Cyclic acid anhydrides such as Succinic anhydride, Adipic anhydride, Octenyl-succinic anhydride, and/or Branched polyethylene amines such as Tetraethylene pentaamine (TEPA) and/or Carboxylating active carbon surfaces using chemical oxidants such as 4-aminobenzoic acid (4-ABA) and/or Carbodiimide activating agents such as 1-Ethyl-3-(3-dimethylaminopropyl) carbodiimide (EDC). Other potential surface modification chemicals include cationic polymers-alkylammonium derivatives and coagulants with high charge densities (pDADMAC), Halide chelation and anionic polymer, surface organic acid functionalisation for biopolymer (CMC-carboxymethylcellulose/cellulose), use of mono- di- and tri-acid functionalities, use range of biopolymers and functional agents, use of epoxy, polymethacrylate-hydrogel and silicone based photocurable polymer resins, rapid photocuring in water and/or organic solvent MECS/other encapsulating methodologies.

The process for amino impregnation onto carrier comprises stirring amino compound and silica aqueous mixture slowly over required amount of time to ensure slow water evaporation.

For example, commercially available mesoporous silica is mixed with amino compound, molecular weight ranging 800-750000 g/mol, at a 5-60 wt % to silica and deionised water. The mixture is stirred at room temperature for 1-24 h. The sample is dried at elevated temperature ranging 25-40° C. (i.e., in an oven for laboratory scale production), or at elevated temperatures of 25-40° C. and sub-atmospheric pressures of 0-1 bar (i.e. in a vacuum oven). The resulting material has a carbon dioxide capacity of 5-15 wt % measured at 25° C. under carbon dioxide flow using thermogravimetric analyser.

### Example 9(a)

1 g commercially available mesoporous silica (PQ) was mixed with polyethylenimine, molecular weight 800 g/mol, at a 50 wt % to silica and 10 ml deionised water. The mixture was stirred at room temperature for 24 h. Sample was dried in a vacuum oven at 40° C. and 700 mbar for 24 h. The resulting material had a carbon dioxide capacity of 11.50 wt % measured at 25° C. for 1 h under 100 ml/min carbon dioxide flow and initial release rate of up to 50% of total adsorbed carbon dioxide ranging 7.3e-4-0.011 mmol/g/h, decelerating to 5e-10 release rate under 100 ml/min N₂ flow using thermogravimetric analyser.

### Example 9(b)

Another PQ silica sample was impregnated with 40 wt % polyethylenimine. The resulting material had a carbon dioxide capacity of 10.77 wt % and initial release rate of up to 50% of total adsorbed carbon dioxide ranging 1.83e-4-0.034 mmol/g/h, decelerating to 1e-10 release rate.

### Example 9(c)

Another PQ silica sample was impregnated with 30 wt % polyethylenimine. The resulting material had a carbon dioxide capacity of 8.61 wt % and initial release rate of up to 50% of total adsorbed carbon dioxide ranging 7.84e-4-0.060 mmol/g/h, decelerating to 5e-10 release rate.

### Example 9(d)

Another PQ silica sample was impregnated with 20 wt % polyethylenimine. The resulting material had a carbon dioxide capacity of 6.61 wt % and initial release rate of up to 50% of total adsorbed carbon dioxide ranging 4.1e-4-0.082 mmol/g/h, decelerating to 3e-10 release rate.

### Example 9(e)

Another PQ silica sample was impregnated with 50 wt % polyethylenimine (molecular weight equal to 1800 g/mol). The resulting material had a carbon dioxide capacity of 9.80 wt % and initial release rate of up to 50% of total adsorbed carbon dioxide ranging 4.6e-4-0.046 mmol/g/h, decelerating to 3e-10 release rate.

### Example 9(f)

Another PQ silica sample was impregnated with 50 wt % polyethylenimine (molecular weight equal to 25000 g/mol). The resulting material had a carbon dioxide capacity of 8.35 wt % and initial release rate of up to 50% of total adsorbed carbon dioxide ranging 7.9e-4-0.079 mmol/g/h, decelerating to 5e-10 release rate. Carbon dioxide uptake by concrete was determined to have a rate of 7.0e-4 mmol/g/h, as determined in a simulated concrete environment.

### Example 9(g)

Another PQ silica sample was impregnated with 50 wt % polyethylenimine (molecular weight equal to 60000 g/mol). The resulting material had a carbon dioxide capacity of 5.49 wt % and initial release rate of up to 50% of total adsorbed carbon dioxide ranging 8.7e-4-0.039 mmol/g/h, decelerating to 6e-10 release rate.

### Example 9(h)

Another PQ silica sample was impregnated with 50 wt % polyethylenimine (molecular weight equal to 750000 g/mol). The resulting material had a carbon dioxide capacity of 5.78 wt % and initial release rate of up to 50% of total adsorbed carbon dioxide ranging 1.5e-4-0.058 mmol/g/h, decelerating to 1e-10 release rate. Carbon dioxide uptake by concrete was determined to have a rate of 0.010 mmol/g/h, as determined in a simulated concrete environment.

### Example 9(i)

Another PQ silica sample was impregnated with 40 wt % polyethylenimine. The resulting material had a carbon dioxide capacity of 13.41 wt % and initial release rate of up to 50% of total adsorbed carbon dioxide ranging 8.6e-4-0.291 mmol/g/h, decelerating to 7e-10 release rate.

### Example 9(j)

Another PQ silica sample was impregnated with 50 wt % polyethylenimine. The resulting material had a carbon dioxide capacity of 13.76 wt % and initial release rate of up to 50% of total adsorbed carbon dioxide ranging 8.7e-4-0.161 mmol/g/h, decelerating to 7e-10 release rate.

### Example 9(k)

Another PQ silica sample was impregnated with 60 wt % polyethylenimine. The resulting material had a carbon dioxide capacity of 9.08 wt % and initial release rate of up to 50% of total adsorbed carbon dioxide ranging 8.9e-4-0.124 mmol/g/h, decelerating to 7e-10 release rate.

### Example 9(k)

An alternative commercially available silica sample (MB) was impregnated with 50 wt % polyethylenimine (molecular weight equal to 800 g/mol). The resulting material had a carbon dioxide capacity of 9.41 wt % and initial release rate of up to 50% of total adsorbed carbon dioxide ranging 3.3e-4-0.018 mmol/g/h, decelerating to 2e-10 release rate.

### Example 9(I)

Another MB silica sample was impregnated with 40 wt % polyethylenimine. The resulting material had a carbon dioxide capacity of 9.29 wt % and initial release rate of up to 50% of total adsorbed carbon dioxide ranging 5.3e-4-0.030 mmol/g/h, decelerating to 3e-10 release rate.

### Example 9(m)

Another MB silica sample was impregnated with 30 wt % polyethylenimine. The resulting material had a carbon dioxide capacity of 7.67 wt % and initial release rate of up to 50% of total adsorbed carbon dioxide ranging 4.6e-4-0.041 mmol/g/h, decelerating to 2e-10 release rate.

### Example 9(n)

Another MB silica sample was impregnated with 20 wt % polyethylenimine. The resulting material had a carbon dioxide capacity of 5.03 wt % and initial release rate of up to 50% of total adsorbed carbon dioxide ranging 1.3e-4-0.002 mmol/g/h, decelerating to 1e-11 release rate.

### Example 9(o)

Another MB silica sample was impregnated with 40 wt % polyethylenimine. The resulting material had a carbon dioxide capacity of 14.26 wt % and initial release rate of up to 50% of total adsorbed carbon dioxide ranging 7.4e-4-0.310 mmol/g/h, decelerating to 5e-10 release rate.

### Example 9(p)

Another MB silica sample was impregnated with 50 wt % polyethylenimine. The resulting material had a carbon dioxide capacity of 13.85 wt % and initial release rate of up to 50% of total adsorbed carbon dioxide ranging 8.7e-4-0.200 mmol/g/h, decelerating to 7e-10 release rate.

### Example 9(q)

Another alternative commercially available silica sample (EH-5) was impregnated with 50 wt % polyethylenimine (molecular weight equal to 800 g/mol). The resulting material had a carbon dioxide capacity of 9.30 wt % and initial release rate of up to 50% of total adsorbed carbon dioxide ranging 6.1e-4-0.025 mmol/g/h, decelerating to 4e-10 release rate.

### Example 9(r)

Another ET-5 silica sample was impregnated with 40 wt % polyethylenimine. The resulting material had a carbon dioxide capacity of 8.56 wt % and initial release rate of up to 50% of total adsorbed carbon dioxide ranging 2.7e-4-0.036 mmol/g/h, decelerating to 1e-10 release rate.

### Example 9(s)

Another ET-5 silica sample was impregnated with 30 wt % polyethylenimine. The resulting material had a carbon dioxide capacity of 7.18 wt % and initial release rate of up to 50% of total adsorbed carbon dioxide ranging 6.2e-4-0.064 mmol/g/h, decelerating to 5e-10 release rate.

### Example 9(t)

Another ET-5 silica sample was impregnated with 20 wt % polyethylenimine. The resulting material had a carbon dioxide capacity of 5.36 wt % and initial release rate of up to 50% of total adsorbed carbon dioxide ranging 5.4e-4-0.060 mmol/g/h, decelerating to 3e-10 release rate.

### Example 9(u)

Another ET-5 silica sample was impregnated with 40 wt % polyethylenimine. The resulting material had a carbon dioxide capacity of 12.67 wt % and initial release rate of up to 50% of total adsorbed carbon dioxide ranging 9.4e-4-0.284 mmol/g/h, decelerating to 7e-10 release rate.

### Example 9(v)

Another ET-5 silica sample was impregnated with 50 wt % polyethylenimine. The resulting material had a carbon dioxide capacity of 13.10 wt % and initial release rate of up to 50% of total adsorbed carbon dioxide ranging 8.3e-4-0.214 mmol/g/h, decelerating to 7e-10 release rate.

### Example 9(w)

Another ET-5 silica sample was impregnated with 60 wt % polyethylenimine. The resulting material had a carbon dioxide capacity of 5.90 wt % and initial release rate of up to 50% of total adsorbed carbon dioxide ranging 8.5e-4-0.021 mmol/g/h, decelerating to 7e-10 release rate.

In all examples, there is a desire to improve the strength, durability, and/or early-stage performance of a concrete material. This is achieved by utilizing a desired amount of modified carrier, loaded with a known amount of carbon dioxide into the concrete-carrier mix, so that there is a known amount of carbon dioxide released into the concrete material once cured.

Selective use of modified carriers can create conditions in which different material properties of the concrete material are produced.

For instance, if a modified carrier is provided which is expected to release 1%, or approximately that amount, of carbon dioxide during the curing process into the concrete material, as measured relative to the weight of the concrete material itself, then over the course of the curing period, one would expect an increase in the compressive strength of the concrete material of between 5 and 25%. Curing periods will vary on the exact cure conditions, but will usually be within a timeframe of 24 to 1344 hours, and more preferably in a range of 48 to 288 hours, and even more preferably 100 hours.

Similarly, for a modified carrier which is expected to release 5%, or approximately that amount, of carbon dioxide during the curing process into the concrete material, as measured relative to the weight of the concrete material itself, then over the course of the curing period, one would expect an increase in the compressive strength of the concrete material of between 10 and 40% Similarly, for a modified carrier which is expected to release 20%, or approximately that amount, of carbon dioxide during the curing process into the concrete material, as measured relative to the weight of the concrete material itself, then over the course of the curing period, one would expect an increase in the compressive strength of the concrete material of between 20 and 100%

By increasing the compressive strength of the concrete material using carbon dioxide sequestration, it becomes possible to reduce the amount of cement material used in the formation of the concrete material, reducing manufacturing cost and having a greater environmental benefit.

The modified carrier can therefore be configured, by treatment and carbon dioxide loading, to desorb, slowly over a curing period, at least 1%, at least 1.5%, at least 2%, at least 2.5%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, or at least 20% of the weight of the concrete material to be produced. Preferably, the modified carrier can be configured by treatment and carbon dioxide loading, to desorb, slowly over a curing period, not more than 100%, not more than 90%, not more than 80%, not more than 70%, not more than 60%, not more than 50%, not more than 40%, not more than 30%, or not more than 20% of the weight of the concrete material to be produced.

It is anticipated that the improvement in compressive strength of the concrete material will be proportional, or at least correlated with, the percentage of carbon dioxide sequestered.

Clause 1: Herein is disclosed a method for extracting, carrying and delivering carbon dioxide from a gas stream to concrete, said method comprising an extraction cycle, wherein said extraction cycle comprises:
a. a sorption step wherein carbon dioxide in said gas stream is adsorbed to a porous material (carrier), wherein said porous material contacts said gas stream;
b. a desorption step wherein said adsorbed carbon dioxide obtained at the end of said sorption step is released from said porous material as gaseous carbon dioxide in concrete or cementitious composites;
c. The released carbon dioxide carbonates concrete, converting calcium hydroxide to calcium carbonate.

Clause 2: Herein disclosed is a method according to clause 1, wherein said method comprises at one or more extraction cycles.

Clause 3: Herein disclosed is a method according to clause 1 or 2, wherein said gas stream includes flue gases, direct air capture and/or high purity carbon dioxide.

Clause 4: Herein disclosed is a method according to any one of clauses 1 to 3, wherein said porous material is a selective carbon dioxide adsorber in said gas stream.

Clause 5: Herein disclosed is a method according to any one of clauses 1 to 4, wherein said porous material may comprise one or more of zeolites, porous aluminosilicate polymorphs, porous carbons, porous polymer networks, porous inorganic oxides, metal-organic-frameworks, zeolitic imidazolate frameworks, diethanolamine upon an (DEA) acrylic ester polymer resin, tetraethylenepentaamineacrylonitrile (TEPAN) upon non-ionic, polymeric polmethylmethacrylate (PMMA) beads, aminopropyltriethoxysilane bonded to silica gel, polyethylenimine (PEI) and polyethylene glycol (PEG) impregnated onto the surface of low cost fly ash derived carbons, PEI immobilised on a mesoporous silica support and polyoligosiloxysilicones.

Clause 6: Herein disclosed is a method according to any one of clauses 1 to 5, wherein said porous material may comprise one or more of zeolites and porous carbons.

Clause 7: Herein disclosed is a method according to clause 6, wherein said porous material may comprise one or more of carbon black, activated carbons, silicalite-1, H-ZSM-5, faujasite, mordenite and zeolite beta.

Clause 8: Herein disclosed is a method according to clause 6, wherein said porous material is a porous carbon.

Clause 9: Herein disclosed is a method according to any one of clauses 1 to 8, wherein said porous material comprises an acid or basic site.

Clause 10: Herein disclosed is a method according to any one of clauses 1 to 9, wherein said desorption step comprises reducing pressure, and/or heating said porous material, and/or bringing said porous material in contact with steam.

Clause 11: Herein disclosed is an apparatus, wherein said apparatus has a fixed-bed/fluidised bed and/or stirred layout, and wherein said apparatus comprises a sealable/open compartments.

1. A method for the improving a strength, durability, and/or early-stage performance of a concrete material, the method comprising the steps of:
providing a carrier suitable for carbon dioxide adsorption;
modifying a surface of the carrier to alter a carbon dioxide desorption rate thereof, forming a modified carrier; the modified carrier being formed by treating the carrier with an activating agent or surface modifying agent, and the activating agent or surface modifying agent being any one of: potassium hydroxide; sodium hydroxide; magnesium hydroxide; magnesium chloride; ammonium chloride; zinc chloride; potassium carbonate; sodium carbonate; potassium tetraborate; potassium oxalate; potassium phosphate; ammonia; nitric acid; hydrochloric acid; phosphoric acid; ammonia; nitric acid; hydrogen cyanide; urea; sodium amide; pyridine; melamine; polyaniline; aminoalkyltrialkoxysilane; cyclic acid anhydride; branched polyethylene amine; chemical oxidants; carbodiimide activating agents; or polymeric surface functionalization compound;
passing carbon dioxide from a carbon dioxide source over the modified carrier to form a carrier comprising adsorbed carbon dioxide;
mixing the carrier comprising adsorbed carbon dioxide into a wet, semi-dry or dry concrete mix to form a concrete carrier mix; and
wherein, during the curing process to form the concrete material, the carbon dioxide is released from the carrier in the concrete-carrier mix and becomes sequestered within the concrete material.

2. A method according to claim 1, wherein the carbon dioxide desorption rate of the modified carrier is in the range of 0.0001 to 0.37 mmol/g/h.

3. A method according to claim 2, wherein the carbon dioxide desorption rate of the modified carrier is in the range of 0.0001 to 0.18 mmol/g/h.

4. A method according to claim 1, wherein a rate of carbon dioxide uptake in the concrete material is less than 0.4 mmol/g/h.

5. A method according to claim 1, wherein the carrier comprising adsorbed carbon dioxide is selected so as to release a predetermined amount of carbon dioxide during the curing process over a predetermined time period, to thereby achieve a desired increase in compressive strength of the concrete material, preferably, wherein the predetermined amount of carbon dioxide is a percentage by weight of carbon dioxide relative to a weight of cement in the concrete-carrier mix, and more preferably wherein the predetermined amount of carbon dioxide is at least 1% carbon dioxide relative to a weight of binder in the concrete-carrier mix within 24 to 1344 hours.

6. (canceled)

7. (canceled)

8. A method as claimed in claim 5, wherein the compressive strength of the concrete material is increased by between 5 and 25%, and/or wherein a weight of binder in the concrete-carrier mix is reduced by between 5 and 20% relative to a standard concrete mix.

9. (canceled)

10. A method as claimed in claim 5, wherein the predetermined amount of carbon dioxide is at least 5% carbon dioxide relative to a weight of binder in the concrete-carrier mix within 24 to 1344 hours.

11. A method as claimed in claim 10, wherein the compressive strength of the concrete material is increased by between 10 and 40%.

12. A method as claimed in claim 10, wherein a weight of binder in the concrete-carrier mix is reduced by between 5 and 35% relative to a standard concrete mix.

13. A method as claimed in claim 5, wherein the predetermined amount of carbon dioxide is at least 20% carbon dioxide relative to a weight of binder in the concrete-carrier mix within 24 to 1344 hours.

14. A method as claimed in claim 13, wherein the compressive strength of the concrete material is increased by between 20 and 100%.

15. A method as claimed in claim 13, wherein a weight of binder in the concrete-carrier mix is reduced by between 20 and 50% relative to a standard concrete mix.

16. A method as claimed in claim 1, wherein the curing process occurs over 2 to 12 days, and wherein at least 50% of the adsorbed carbon dioxide of the modified carrier is released during the curing process.

17. A method according to claim 1, wherein heat, reduced pressure and/or steam is applied to the concrete-carrier mix.

18. A method according to claim 1, wherein the carbon dioxide is passed over the carrier under pressure to form the carrier comprising adsorbed carbon dioxide.

19. A method according to claim 1, wherein the adsorption of carbon dioxide to form the carrier comprising adsorbed carbon dioxide takes place in a fluidised bed reactor, fixed bed reactor or in a stirred tank reactor in order to adsorb CO₂ and transfer it to cementitious material.

20. A method according to claim 1, wherein the source of carbon dioxide is flue gases, atmospheric air, or a gas canister.

21. A method as claimed in claim 1, wherein the carrier comprises any one of activated carbon; a silica support; zeolites; porous aluminosilicate polymorphs; porous carbons; porous polymer networks; porous inorganic oxides; metal-organic-frameworks, zeolitic imidazolate frameworks; diethanolamine (DEA) upon an acrylic ester polymer resin; polymeric polmethylmethacrylate (PMMA) beads; aminopropyltriethoxysilane bonded to silica gel; polyethylenimine (PEI) and polyethylene glycol (PEG) impregnated onto the surface of fly ash derived carbons; PEI immobilized on a mesoporous silica support; and polyoligosiloxysilicones.

22. A method according to claim 1, wherein the concrete mix comprises one or more of ground granulated blast furnace slag and/or fly ash, Cement type 1, 2, 3, 4 or 5 and/or any other cementitious material.

23. A method according to claim 1, wherein an amount of binder in the concrete mix is reduced based on a selected amount of modified carrier added.
